(19) United States
(12) Patent Application Publication
(10) Pub. No.: US 2026/0292093 A1
(43) Pub. Date: Sep. 24, 2026

(54) METHOD OF CREATING PROOF IMAGE DATA, PROOF IMAGE DATA CREATION DEVICE, AND NON-TRANSITORY COMPUTER-READABLE STORAGE MEDIUM STORING COMPUTER PROGRAM

(71) Applicant: SEIKO EPSON CORPORATION, TOKYO (JP)

(72) Inventors: Yuko YAMAMOTO, SHIOJIRI-SHI (JP); Takuya ONO, SHIOJIRI-SHI (JP); Takahiro KAMADA, MATSUMOTO-SHI (JP); Mitsuhiro YAMASHITA, MATSUMOTO-SHI (JP)

(21) Appl. No.: 19/403,320

(22) Filed: Nov. 28, 2025

(30) Foreign Application Priority Data
Nov. 28, 2024 (JP) 2024-207035

(51) Int. Cl. H04N 1/54; H04N 1/00

(52) U.S. Cl. CPC H04N 1/54; H04N 1/0044

(57) ABSTRACT

A method of the disclosure includes (a) acquiring basic proof image data for reproducing a color of a basic printed matter obtained by applying a basic backing to a translucent print fabric, (b) acquiring texture information of the translucent fabric, (c) acquiring a basic backing color and an observation backing color, (d) creating foreground color proof image data by removing the basic backing color from the basic proof image data, and (e) creating observation proof image data by synthesizing the observation backing color with the foreground color proof image data.

The present application is based on, and claims priority from JP Application Serial Number 2024-207035, filed Nov. 28, 2024, the disclosure of which is hereby incorporated by reference herein in its entirety.

### BACKGROUND

### 1. Technical Field

The present disclosure relates to a method of creating proof image data, a proof image data creation device, and a non-transitory computer-readable storage medium storing a computer program.

### 2. Related Art

JP-A-09-270930 discloses a method for creating a proof image for proofreading a printed matter. In the related art, a proof image is created by correcting an image based on a density distribution on a two-dimensional space of a surface of a printed matter printed on a printing medium at a density of 100%.

JP-A-09-270930 is an example of the related art.

In a print fabric obtained by printing an image on a see-through fabric, an apparent color of the print fabric greatly changes depending on a color of a backing (backing material). However, in the related art, a technique of creating a proof image in consideration of the color of the backing for the see-through print fabric is not known. Therefore, there is a demand for a technique capable of generating proof image data for reproducing a printed matter observed when a backing of an optional color is used for a see-through print fabric.

### SUMMARY

According to a first aspect of the present disclosure, a method of creating proof image data is provided. The method includes (a) acquiring basic proof image data for reproducing, by a proof output device, a color of a basic printed matter obtained by applying a basic backing to a translucent print fabric formed by printing an image on a translucent fabric by a printing machine, (b) acquiring texture information of the translucent fabric, (c) acquiring a basic backing color that is a color of the basic backing and an observation backing color that is a color of an observation backing used in an observation environment of the translucent print fabric, (d) creating foreground color proof image data representing a color of the translucent print fabric observed without using a backing by executing color correction processing of removing the basic backing color from a color represented by the basic proof image data according to the texture information, and (e) creating observation proof image data representing a color of an observation printed matter obtained by applying the observation backing to the translucent print fabric by executing synthesis processing of synthesizing the observation backing color with a color represented by the foreground color proof image data according to the texture information.

According to a second aspect of the present disclosure, a proof image data creation device is provided. The proof image data creation device includes a basic proof image acquisition unit that acquires basic proof image data for reproducing, by a proof output device, a color of a basic printed matter obtained by applying a basic backing to a translucent print fabric formed by printing an image on a translucent fabric by a printing machine, a texture information acquisition unit that acquires texture information of the translucent fabric, a backing color information acquisition unit that acquires a basic backing color that is a color of the basic backing and an observation backing color that is a color of an observation backing used in an observation environment of the translucent print fabric, a color correction unit that creates foreground color proof image data representing a color of the translucent print fabric observed without using a backing by executing color correction processing of removing the basic backing color from the color represented by the basic proof image data according to the texture information, and a synthesis unit that creates observation proof image data representing a color of an observation printed matter obtained by applying the observation backing to the translucent print fabric by executing synthesis processing of synthesizing the observation backing color with a color represented by the foreground color proof image data according to the texture information.

According to a third aspect of the present disclosure, a non-transitory computer-readable storage medium storing a computer program for creating proof image data is provided. The computer program causes a computer to execute processing (a) of acquiring basic proof image data for reproducing, by a proof output device, a color of a basic printed matter obtained by applying a basic backing to a translucent print fabric formed by printing an image on a translucent fabric by a printing machine, processing (b) of acquiring texture information of the translucent fabric, processing (c) of acquiring a basic backing color that is a color of the basic backing and an observation backing color that is a color of an observation backing used in an observation environment of the translucent print fabric, processing (d) of creating foreground color proof image data representing a color of the translucent print fabric observed without using a backing by executing color correction processing of removing the basic backing color from a color represented by the basic proof image data according to the texture information, and processing (e) of creating observation proof image data representing a color of an observation printed matter obtained by applying the observation backing to the translucent print fabric by executing synthesis processing of synthesizing the observation backing color with a color represented by the foreground color proof image data according to the texture information.

### BRIEF DESCRIPTION OF THE DRAWINGS

FIG. 1 shows a printing system for proofreading a printed matter.

FIG. 2 is a block diagram showing a configuration of a proof image data creation device.

FIG. 3 shows a flow of proof image creation processing.

FIG. 4 shows examples of a translucent print fabric to which different backings are applied.

FIG. 5 is a flowchart showing a procedure of creation processing of proof image data.

FIG. 6 shows an example of texture values.

FIG. 7 shows an example of a window used for acquiring transmission characteristic information.

FIG. 8 shows an example of a window used for acquiring backing color information.

FIG. 9 is a flowchart showing a detailed procedure of step S40.

FIG. 10 is a graph showing an example of a background reference rate determination curve.

FIG. 11 shows a flow of proof image creation processing in a second embodiment.

### DESCRIPTION OF EMBODIMENTS

### A. First Embodiment

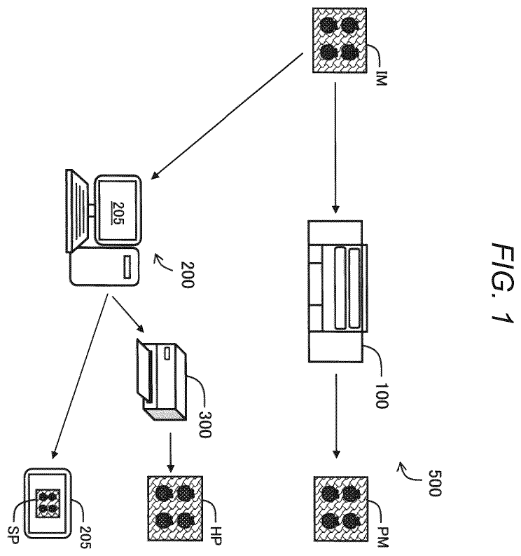

FIG. 1 shows a printing system 500 for proofreading a printed matter. The printing system 500 includes a printing machine 100 that prints a printed matter PM according to input image data IM, a proof image data creation device 200 that creates proof image data using the input image data IM, and a proofreading printing device 300 that prints a proof according to the proof image data.

Proofreading includes hard proof of printing a proof print HP using the proofreading printing device 300 and soft proof of displaying a proof image SP on a display device 205 according to the proof image data. In the hard proof, the proofreading printing device 300 corresponds to a “proof output device”, and in the soft proof, the display device 205 corresponds to a “proof output device”. The image output from the proof output device is also referred to as an “output image”. The proof print HP corresponds to the “output image” in the hard proof, and the proof image SP corresponds to the “output image” in the soft proof.

The printing machine 100 is, for example, a textile printing machine that creates a print fabric by performing textile printing on a fabric printing medium. In the present embodiment, a see-through fabric is used as the printing medium. As the see-through fabric, for example, woven fabrics such as chiffon, tulle, organdy, georgette, lace, mesh, lawn, and gauze can be used. A see-through fabric is referred to as a “translucent fabric”. A translucent fabric with an image printed thereon is referred to as a “translucent print fabric”.

The proof image data creation device 200 is configured to execute at least one of the hard proof and the soft proof. In the hard proof, the proofreading printing device 300 prints the proof print HP according to the proof image data created by the proof image data creation device 200. When the proofreading printing device 300 is an inkjet printer, the proof image data creation device 200 creates dot data for printing by applying color conversion processing or halftone processing to the proof image data, and supplies the dot data to the proofreading printing device 300 to execute printing of the proof print HP. In the soft proof, the proof image SP is displayed on the display device 205 according to the proof image data created by the proof image data creation device 200. The present disclosure is applicable to both the hard proof and the soft proof.

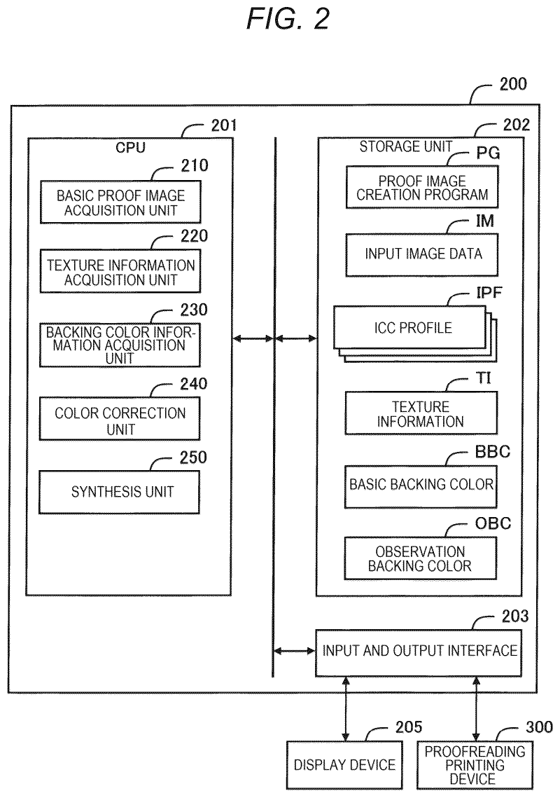

FIG. 2 is a block diagram showing a configuration of the proof image data creation device 200. The proof image data creation device 200 is a computer including a CPU 201, a storage unit 202, an input and output interface 203, and the display device 205. The CPU 201, the storage unit 202, and the input and output interface 203 are coupled to one another via an internal bus so as to be capable of bidirectional communication.

The CPU 201 functions as a basic proof image acquisition unit 210, a texture information acquisition unit 220, a backing color information acquisition unit 230, a color correction unit 240, and a synthesis unit 250 by executing a proof image creation program PG stored in advance in the storage unit 202. At least part of the functions of these units 210 to 250 may be implemented by a hardware circuit or may be implemented on a cloud.

The input and output interface 203 is coupled to the display device 205 and the proofreading printing device 300 in a wired or wireless manner. The display device 205 is used to display a window and a proof image described later.

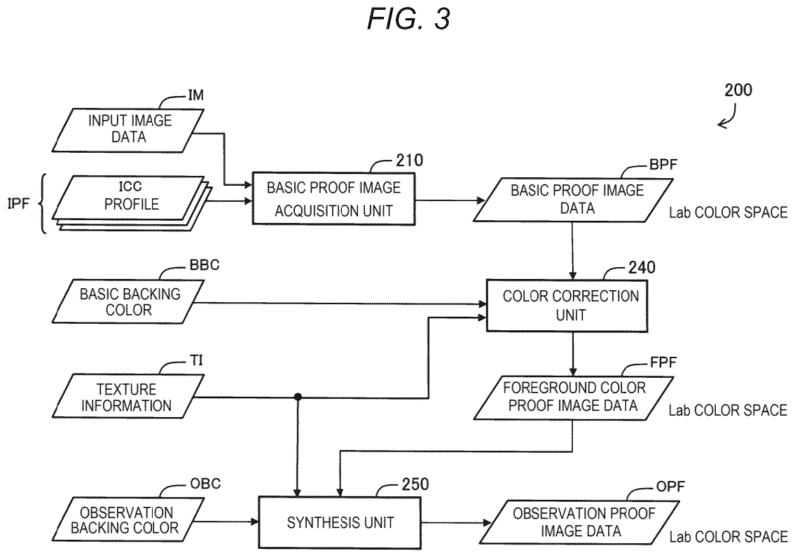

FIG. 3 shows a flow of proof image creation processing. The basic proof image acquisition unit 210 acquires basic proof image data BPF. The basic proof image data BPF is data in which a difference in color reproduction between the printing machine 100 and the proof output device is reflected on the input image data IM. In the present embodiment, the basic proof image data BPF is data for the proof output device to reproduce the color of a basic printed matter obtained by applying a basic backing to the translucent print fabric printed by the printing machine 100.

The “backing” refers to a backing material for the print fabric. In a typical example, a basic backing is used for creating a media profile of the printing machine 100 regarding the translucent fabric. That is, first, a plurality of color patches are printed on the translucent fabric using the printing machine 100. Then, color measurement is performed in a state where a basic backing is applied to the translucent fabric with the color patches printed thereon, and a media profile is created using the color measurement result. The basic backing may be referred to as a “backing for color measurement”.

In the present embodiment, the basic proof image acquisition unit 210 creates the basic proof image data BPF from the input image data IM. In the creation processing, for example, various ICC profiles such as an input profile of the input image data IM, a device profile and a media profile of the proof output device, and the media profile of the printing machine 100 are used. However, when the basic proof image data BPF is already created, the basic proof image acquisition unit 210 may acquire the basic proof image data BPF by reading the data from the storage unit 202.

Any method can be used as a method of creating the basic proof image data BPF. For example, a method described in JP-A-2024-81234 disclosed by the applicant of the present disclosure may be used. In this method, the following processing is sequentially executed.

### Processing P1

First image data is acquired by converting the color space of the input image data IM into the output color space of the printing machine 100 using the ICC profile IPF.

### Processing P2

Second image data represented in an absolute XYZ color space is acquired by performing, on the first image data, conversion using a first conversion table into representation in a profile connection space and white point conversion using information on an appearance in a predetermined observation environment of a ground color portion with no image in the printed matter PM.

### Processing P3

The second image data is converted into converted image data represented in the output color space of the proof output device by using a second conversion table. The output color space of the proof output device is, for example, a CMYK color space or an RGB color space.

The proof image may be created by using the method described in the related art (JP-A-09-270930) or JP-A-2006-30277. When the method in JP-A-09-270930 is used, the basic proof image data BPF in which the texture is not reflected can be created by executing processing in which the first correction and the second correction related to a texture of paper are omitted.

In the first embodiment, the basic proof image data BPF is represented in an L*a*b* color space. However, it may be represented by another device-independent color space such as an XYZ color space. When the basic proof image data represented in the output color space of the proof output device is created using the above-described various methods, the output color space can be converted into the L*a*b* color space using an output profile of the proof output device. When the method described in JP-A-2024-81234 is used, the basic proof image data BPF may be created by converting the second image data represented in the absolute XYZ color space into the L*a*b* color space. In the following description, L*a*b* is simply referred to as “Lab”.

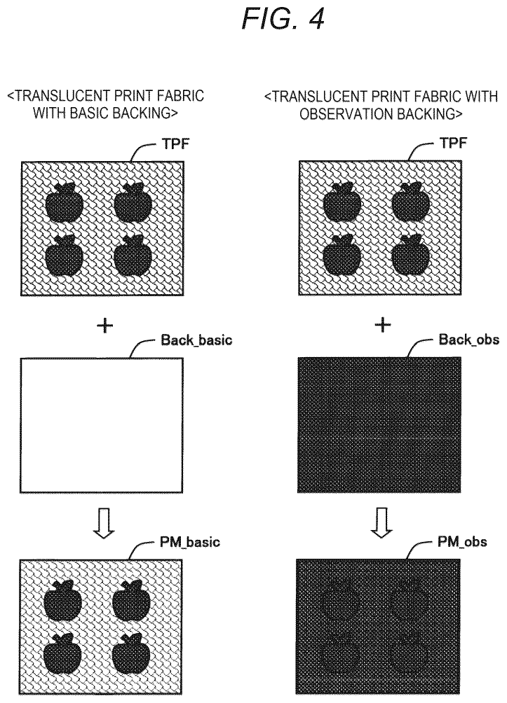

FIG. 4 shows examples of a translucent print fabric to which different backings are applied. On the left side in FIG. 4, a basic printed matter PM_basic in a state where a basic backing Back_basic is applied to a translucent print fabric TPF without a backing is shown. The color of the basic backing Back_basic is, for example, white. On the right side in FIG. 4, an observation printed matter PM_obs in a state where an observation backing Back_obs is applied to the translucent print fabric TPF without a backing is shown. The color of the observation backing Back_obs is, for example, black. In the present embodiment, not only a proof of the basic printed matter PM_basic to which the basic backing Back_basic is applied can be created, but also a proof of the observation printed matter PM_obs to which the observation backing Back_obs of an optional color is applied can be created. The basic proof image data BPF is data representing the color of the basic printed matter PM_basic.

The color correction unit 240 illustrated in FIG. 3 creates foreground color proof image data FPF by executing color correction processing of removing a basic backing color BBC from the color represented by the basic proof image data BPF according to texture information TI. The foreground color proof image data FPF is data representing the color of the translucent print fabric TPF observed without using a backing. In the present embodiment, the foreground color proof image data FPF is represented in the Lab color space.

The synthesis unit 250 creates observation proof image data OPF by executing synthesis processing of synthesizing the observation backing color OBC with the color represented by the foreground color proof image data FPF according to the texture information TI. The observation proof image data OPF is data representing the color of the observation printed matter PM_obs described with reference to FIG. 4. In the present embodiment, the observation proof image data OPF is represented in the Lab color space.

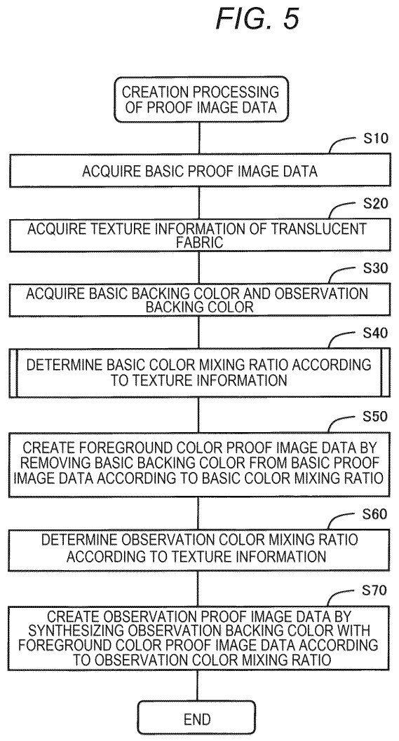

FIG. 5 is a flowchart showing a procedure of creation processing of the proof image data. In step S10, the basic proof image acquisition unit 210 acquires the basic proof image data BPF. In step S20, the texture information acquisition unit 220 acquires the texture information TI of the translucent fabric. In the present embodiment, the texture information TI includes a texture value for each pixel and transmission characteristic information.

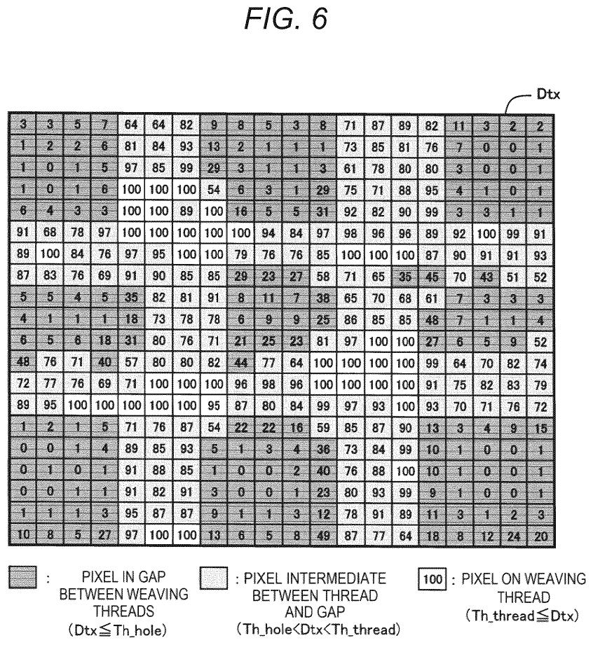

FIG. 6 shows an example of texture values Dtx as the texture information TI. As the texture values Dtx, a lightness value map generated based on image data obtained by capturing a printing medium or a Height Map used in 3D rendering can be used. In either case, the texture values Dtx are preferably configured as a map of values indicating the brightness or unevenness of the print medium. In the example of FIG. 6, the texture value Dtx is a value in a range from 0 (black) to 100 (white). The image area of the texture values Dtx preferably has the same size as the image area of the basic proof image data BPF. The texture values Dtx can be acquired using known technology or, for example, a texture information acquisition device described in JP Application No. 2024-116006 disclosed by the applicant of the present disclosure.

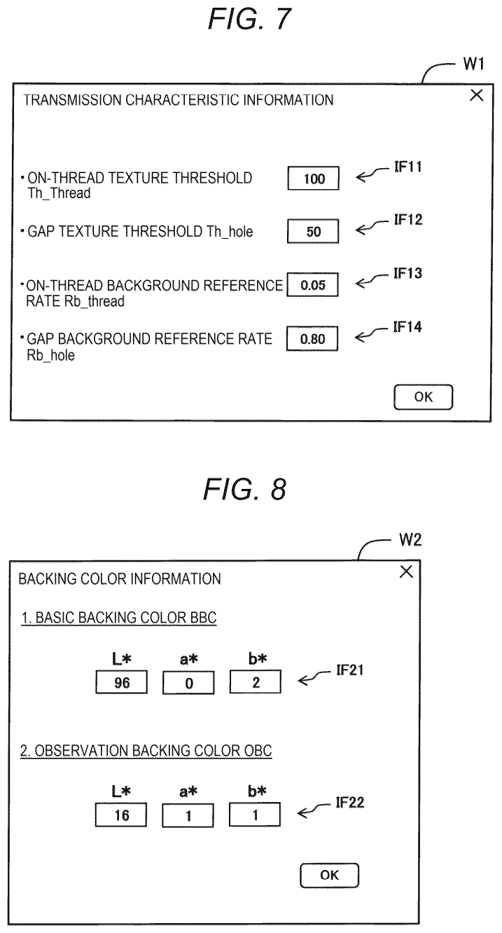

FIG. 7 shows an example of a window W1 used for acquiring the transmission characteristic information as the texture information TI. The window W1 is provided with four input fields IF11 to IF14 for inputting the following four setting values forming the transmission characteristic information.

### (A) On-Thread Texture Threshold Th_thread

An on-thread texture threshold Th_thread is the minimum value of the texture value Dtx for determining that each pixel corresponds to a portion on the weaving thread of the translucent fabric. That is, a pixel having the texture value Dtx equal to or greater than the on-thread texture threshold Th_thread is determined to correspond to a portion on the weaving thread. The on-thread texture threshold Th_thread is set to, for example, a value more than 0 and 100 or less. In FIG. 6 described above, the pixel determined to correspond to a portion on the weaving thread when Th_thread=100 is shown as a white area without hatching.

### (B) Gap Texture Threshold Th_hole

A gap texture threshold Th_hole is the maximum value of the texture value Dtx for determining that each pixel corresponds to a gap between weaving threads of the translucent fabric. That is, a pixel having the texture value Dtx equal to or less than the gap texture threshold Th_hole is determined to correspond to a gap between weaving threads. The gap texture threshold Th_hole is set to, for example, a value of 0 or more and less than 100. Further, the gap texture threshold Th_hole is set to a value (darker value) smaller than the on-thread texture threshold Th_thread. In the example of FIG. 6 described above, a pixel determined to correspond to a gap between weaving threads when Th_hole=50 is shown as a dark gray area. Further, a pixel having intermediate lightness between the thread and the gap is shown as a light gray area.

### (C) On-Thread Background Reference Rate Rb_thread

An on-thread background reference rate Rb_thread is a rate for reference to the backing color in the pixel corresponding to the weaving thread. As the backing color, the basic backing color or the observation backing color is referred to. The on-thread background reference rate Rb_thread is set to, for example, a value from 0 to 1.0.

### (D) Gap Background Reference Rate Rb_hole

A gap background reference rate Rb_hole is a rate for reference to the backing color in the pixel corresponding to the gap. The gap background reference rate Rb_hole is set to, for example, a value from 0 to 1.0. The gap background reference rate Rb_hole is set to a value larger than the on-thread background reference rate Rb_thread.

Instead of a user inputting the on-thread background reference rate Rb_thread and the gap background reference rate Rb_hole, the on-thread background reference rate Rb_thread and the gap background reference rate Rb_hole may be set using transparency obtained from a captured image using a white background and a black background described in JP-A-2005-251162. For example, the minimum value of the transparency of the fabric may be set as the on-thread background reference rate Rb_thread, and the maximum value of the transparency of the fabric may be set as the gap background reference rate Rb_hole.

The transmission characteristic information set in FIG. 7 is used in the color correction processing executed by the color correction unit 240 and the synthesis processing executed by the synthesis unit 250. The details of the color correction processing and the synthesis processing will be described later.

In step S30 of FIG. 5, the backing color information acquisition unit 230 acquires backing color information including the basic backing color BBC and the observation backing color OBC.

FIG. 8 shows an example of a window W2 used for acquiring the backing color information. The window W2 is provided with an input field IF21 for inputting the basic backing color BBC and an input field IF22 for inputting the observation backing color OBC. In the present embodiment, the basic backing color BBC and the observation backing color OBC are respectively set by Lab values. In the example of FIG. 8, the basic backing color BBC is white, and the observation backing color OBC is black.

The basic backing color BBC and the observation backing color OBC may be acquired as an image. That is, the backing color information acquisition unit 230 may acquire a Lab image of the observation backing color OBC designated by the user.

In step S40 of FIG. 5, the color correction unit 240 determines the basic color mixing ratio according to the texture information TI. The basic color mixing ratio is a color mixing ratio of the basic backing color BBC when the color of the basic printed matter PM_basic described with reference to FIG. 4 is regarded as a color mixture of the color of the translucent print fabric TPF and the basic backing color BBC. In other words, the basic color mixing ratio is a color mixing ratio of the basic backing color BBC when the color represented by the basic proof image data BPF is regarded as a color mixture of the color represented by the foreground color proof image data FPF and the basic backing color BBC.

When the basic color mixing ratio is Rmix_basic, the color mixture with respect to the basic proof image data BPF is expressed by the following expression

Lab_basic=Lab_fore×(1−Rmix_basic)+Lab_b.back×Rmix_basic . . . (q1)

where Lab_basic is a Lab value of the basic proof image data BPF, Lab_fore is a Lab value of the foreground color proof image data FPF, and Lab_b.back is a Lab value of the basic backing color BBC.

The basic color mixing ratio Rmix_basic is a value more than 0 and less than 1.0.

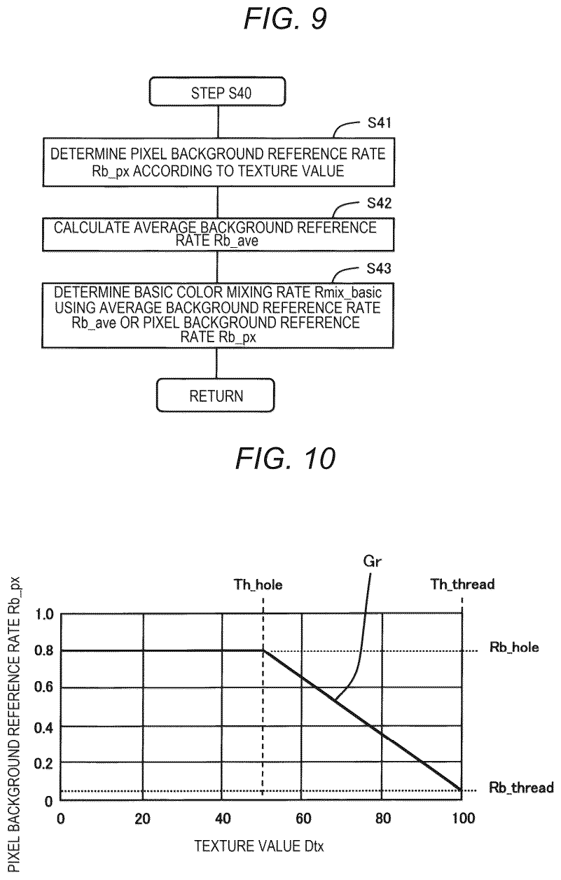

FIG. 9 is a flowchart showing a detailed procedure of step S40. In step S41, the color correction unit 240 determines a pixel background reference rate Rb_px, which is a background reference rate of each pixel, according to the texture value Dtx using a background reference rate determination curve determined by the transmission characteristic information.

FIG. 10 is a graph showing an example of the background reference rate determination curve Gr. The background reference rate determination curve Gr preferably has a characteristic that the pixel background reference rate Rb_px is lower as the lightness represented by the texture value Dtx is higher. The pixel background reference rate Rb_px is determined as follows according to the texture value Dtx of each pixel.
(a1) Pixel having texture value Dtx equal to or less than gap texture threshold Th_hole:

The pixel background reference rate Rb_px is determined as a value equal to the gap background reference rate Rb_hole.
(a2) Pixel having texture value Dtx that satisfies Th_hole<Dtx<Th_thread:

The pixel background reference rate Rb_px is determined by linear interpolation between the on-thread background reference rate Rb_thread and the gap background reference rate Rb_hole according to the texture value Dtx.
(a3) Pixel having texture value Dtx equal to or more than on-thread texture threshold Th_thread:

The pixel background reference rate Rb_px is determined as a value equal to the on-thread background reference rate Rb_thread.

Instead of inputting the setting value of the transmission characteristic information illustrated in FIG. 7, an image of the pixel background reference rate Rb_px may be acquired as the transmission characteristic information. That is, the texture information acquisition unit 220 may acquire a map of the pixel background reference rate Rb_px designated by the user. In this case, the map of the pixel background reference rate Rb_px preferably has the same image area as the image area of the basic proof image data BPF.

In step S42, the color correction unit 240 calculates an average background reference rate Rb_ave by averaging the pixel background reference rates Rb_px in the image area of the basic proof image data BPF.

In step S43, the color correction unit 240 determines the basic color mixing ratio Rmix_basic using the average background reference rate Rb_ave or the pixel background reference rate Rb_px. For example, the basic color mixing ratio Rmix_basic is determined by one of the following expressions

Rmix_basic=Rb_ave . . . (q2-1)

Rmix_basic=Rb_px . . . (q2-2).

As the basic color mixing ratio Rmix_basic, a positive value proportional to the average background reference rate Rb_ave or the pixel background reference rate Rb_px can be used instead of the value itself of the average background reference rate Rb_ave or the pixel background reference rate Rb_px.

When the basic color mixing ratio Rmix_basic is determined using the average background reference rate Rb_ave, a constant basic color mixing ratio Rmix_basic is applied to the entire image area. In contrast, when the basic color mixing ratio Rmix_basic is determined using the pixel background reference rate Rb_px, a different basic color mixing ratio Rmix_basic is applied for each pixel. In the latter case, step S42 may be omitted. However, the basic color mixing ratio Rmix_basic is preferably determined using the average background reference rate Rb_ave rather than the pixel background reference rate Rb_px. This is because, when the basic color mixing ratio Rmix_basic is determined using the pixel background reference rate Rb_px, the correction amount in the color correction processing in step S50 becomes excessively larger in the gap portion between fibers, and the color of the foreground color proof image data FPF may not be correctly obtained. In an actual translucent print fabric, spatial color mixture of the gap portion and the thread portion is produced, and it is considered that an averaged color is seen when observed from a distance. Therefore, in the color correction processing, it is preferable to generate the foreground color proof image data FPF so as to more accurately represent the actually observed color of the translucent print fabric by removing the basic backing color using the average background reference rate Rb_ave.

In step S50 of FIG. 5, the color correction unit 240 executes color correction processing of removing the basic backing color BBC from the color represented by the basic proof image data BPF according to the basic color mixing ratio Rmix_basic, and creates the foreground color proof image data FPF. As described above, the foreground color proof image data FPF is data representing the color of the translucent print fabric TPF observed without using a backing.

The calculation of step S50 is executed, for example, according to the following expression

Lab_fore=(Lab_basic−Lab_b.back×Rmix_basic)/(1−Rmix_basic) . . . (q3)

where Lab_fore is the Lab value of the foreground color proof image data FPF, Lab_basic is the Lab value of the basic proof image data BPF, Lab_b.back is the Lab value of the basic backing color BBC, and Rmix_basic is the basic color mixing ratio.

The calculation by the expression (q3) is executed for each of the L value, the a value, and the b value of the basic proof image data BPF. The expression (q3) corresponds to a modification of the expression (q1) described above.

The foreground color proof image data FPF may be obtained using the following expression instead of the above equation (q3)

Lab_fore=(Lab_basic−α×Lab_b.back×Rmix_basic)/(1−Rmix_basic) . . . (q4)

where α is a freely selected positive coefficient other than 0.

The coefficient α is a coefficient for adjusting the strength of the influence of the basic backing color BBC. As the coefficient α, a value close to 1 is preferably used. When α=1, the expression (q4) is the same as the expression (q3), and thus the expression (q4) is an expression including the expression (q3) in a broad sense.

In step S60 of FIG. 5, the color correction unit 240 determines the observation color mixing ratio according to the texture information TI. The observation color mixing ratio is a color mixing ratio when the color of the observation printed matter PM_obs described with reference to FIG. 4 is regarded as a color mixture of the color of the translucent print fabric TPF and the observation backing color OBC. In other words, the observation color mixing ratio is a color mixing ratio when the color represented by the observation proof image data OPF is regarded as a color mixture of the color represented by the foreground color proof image data FPF and the observation backing color OBC.

In the present embodiment, a positive value proportional to the average background reference rate Rb_ave or the pixel background reference rate Rb_px is used as the observation color mixing ratio Rmix_obs. For example, the value itself of the average background reference rate Rb_ave or the pixel background reference rate Rb_px may be used as the observation color mixing ratio Rmix_obs. It can be considered that the synthesis unit 250 executes the same processing as that in step S41 to S43 shown in FIG. 9 as the processing of obtaining the observation color mixing ratio Rmix_obs.

The observation color mixing ratio Rmix_obs may be the same as or different from the basic color mixing ratio Rmix_basic described above. However, it is preferable to use a value proportional to the average background reference rate Rb_ave as the basic color mixing ratio Rmix_basic and a value proportional to the pixel background reference rate Rb_px as the observation color mixing ratio Rmix_obs. When a value proportional to the pixel background reference rate Rb_px is used as the observation color mixing ratio Rmix_obs, the difference between the background and the foreground color in the thread portion and the gap portion becomes clear, so that the texture of the translucent fabric can be reproduced more appropriately.

In step S70 of FIG. 5, the synthesis unit 250 executes synthesis processing of synthesizing the observation backing color OBC with the color represented by the foreground color proof image data FPF according to the observation color mixing ratio Rmix_obs, thereby creating the observation proof image data OPF. The observation proof image data OPF is data representing the color of the observation printed matter PM_obs described with reference to FIG. 4.

The synthesis processing is executed according to, for example, the following expression

Lab_obs=Lab_fore×(1−Rmix_obs)+Lab_o.back×Rmix_obs . . . (q5)

where Lab_obs is the Lab value of the observation proof image data OPF, Lab_fore is the Lab value of the foreground color proof image data FPF, Lab_o.back is the Lab value of the observation backing color OBC, and Rmix_obs is the observation color mixing ratio.

By using the observation proof image data OPF generated in this manner, it is possible to reproduce, as a proof, the observation printed matter PM_obs of the translucent print fabric TPF observed when an optional observation backing Back_obs is used.

In the first embodiment described above, after the foreground color proof image data FPF is generated by removing the basic backing color BBC from the color represented by the basic proof image data BPF, the observation backing color OBC is synthesized with the color represented by the foreground color proof image data FPF. As a result, it is possible to create a proof in consideration of the observation backing color OBC that can be seen through the fabric under the observation environment of the translucent print fabric.

### B. Second Embodiment

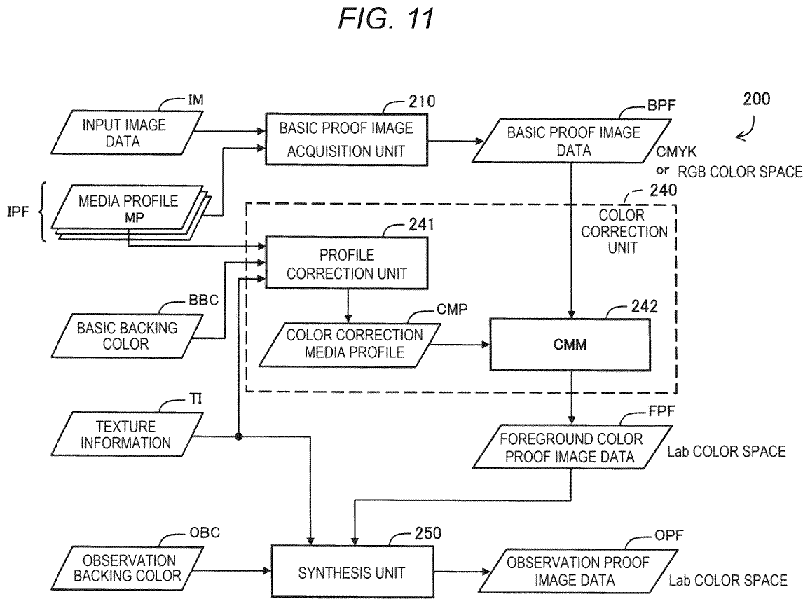

FIG. 11 shows a flow of proof image creation processing in the second embodiment. There are the following two main differences from the first embodiment shown in FIG. 3.
(1) The basic proof image data BPF is represented by an RGB color space or a CMYK color space as an output color space of the proof output device.
(2) The color correction unit 240 includes a profile correction unit 241 and a color management module 242.

The profile correction unit 241 executes profile conversion on the media profile MP of the printing machine 100 related to the translucent fabric using the basic backing color BBC and the basic color mixing ratio Rmix_basic determined according to the texture information TI, thereby generating the color correction media profile CMP related to the translucent fabric without using the basic backing Back_basic. This profile conversion is processing of changing the Lab value of an A2B table of the media profile MP. The A2B table is a table for converting the CMYK color space into the Lab color space.

The calculation of profile conversion is a calculation of removing the basic backing color BBC from the color represented by device-independent color space data in the media profile MP according to the basic color mixing ratio Rmix_basic, and is executed using the following expression similar to the expression (q4)

Lab_corrected=(Lab_org−α×Lab_b.back×Rmix_basic)/(1−Rmix_basic) . . . (q6)

where Lab_corrected is a Lab value of device-independent color space data after profile conversion, Lab_org is a Lab value of device-independent color space data before profile conversion, Lab_b.back is the Lab value of the basic backing color BBC, Rmix_basic is the basic color mixing ratio, and α is a freely selected positive coefficient other than 0.

As the basic color mixing ratio Rmix_basic, a value proportional to the average background reference rate Rb_ave is preferably used.

The color management module 242 creates the foreground color proof image data FPF by executing color management processing of converting the basic proof image data BPF into a device-independent color space using the color correction media profile CMP. Specifically, the color space of the basic proof image data BPF is converted from the output color space CMYK of the proof output device to the device-independent color space Lab by using the A2B table of the color correction media profile CMP. By this color conversion, foreground color proof image data FPF represented by the device-independent color space Lab is generated.

Since the other processing of the second embodiment is the same as that of the first embodiment, the description thereof will be omitted. The second embodiment also achieves substantially the same effects as those of the above-described first embodiment.

### Other Configurations

The present disclosure is not limited to the embodiments described above, and can be implemented in various configurations without departing from the spirit of the present disclosure. For example, the present disclosure may also be implemented in the following configurations. To solve a part or all of the problems of the present disclosure or to achieve a part or all of the advantages of the present disclosure, the technical features in the above-described embodiments corresponding to the technical features in the following configurations can be replaced or combined as appropriate. The technical features can be deleted as appropriate unless described as being essential in the specification.
(1) According to a first aspect of the present disclosure, a method of creating proof image data is provided. The method includes (a) acquiring basic proof image data for reproducing, by a proof output device, a color of a basic printed matter obtained by applying a basic backing to a translucent print fabric formed by printing an image on a translucent fabric by a printing machine, (b) acquiring texture information of the translucent fabric, (c) acquiring a basic backing color that is a color of the basic backing and an observation backing color that is a color of an observation backing used in an observation environment of the translucent print fabric, (d) creating foreground color proof image data representing a color of the translucent print fabric observed without using a backing by executing color correction processing of removing the basic backing color from a color represented by the basic proof image data according to the texture information, and (e) creating observation proof image data representing a color of an observation printed matter obtained by applying the observation backing to the translucent print fabric by executing synthesis processing of synthesizing the observation backing color with a color represented by the foreground color proof image data according to the texture information.

According to this method, it is possible to create a proof in consideration of the observation backing color that can be seen through the translucent print fabric under the observation environment of the translucent print fabric.
(2) In the above method, (d) may include (d1) determining a basic color mixing ratio of the basic backing color when the color of the basic printed matter is regarded as a color mixture of the color of the translucent print fabric and the basic backing color according to the texture information, and (d2) creating the foreground color proof image data by executing a calculation of removing the basic backing color from the color represented by the basic proof image data according to the basic color mixing ratio.

According to the method, the foreground color proof image data can be created by removing the basic backing color from the color represented by the basic proof image data using the basic color mixing ratio determined according to the texture information.
(3) In the above method, the basic proof image data may be data represented in an output color space of the proof output device. (d) may include (d1) determining a basic color mixing ratio of the basic backing color when the color of the basic printed matter is regarded as a color mixture of the color of the translucent print fabric and the basic backing color according to the texture information, (d2) generating a color correction media profile related to the translucent fabric without the basic backing by executing profile conversion on a media profile of the printing machine related to the translucent fabric using the basic backing color and the basic color mixing ratio, and (d3) creating the foreground color proof image data by executing color management processing of converting the basic proof image data into a device-independent color space using the color correction media profile.

According to the method, the foreground color proof image data can be created by performing the color management processing on the basic proof image data using the color correction media profile.
(4) In the above method, the texture information may include transmission characteristic information of the translucent fabric and a texture value for each pixel. (d1) may include (d1-1) determining a pixel background reference rate that is a rate of reference to a backing color in each pixel according to the texture value using the transmission characteristic information, and (d1-2) determining a value proportional to one of an average background reference rate obtained by averaging the pixel background reference rates in an image area of the basic proof image data and the pixel background reference rate as the basic color mixing ratio.

According to the method, the basic color mixing ratio can be determined using the transmission characteristic information and the texture value of the texture information.
(5) In the above method, the transmission characteristic information may include an on-thread texture threshold for determining that each pixel corresponds to a portion on a weaving thread of the translucent fabric, a gap texture threshold for determining that each pixel corresponds to a gap between weaving threads of the translucent fabric, an on-thread background reference rate that is a rate of reference to the backing color in the pixel corresponding to the weaving thread, and a gap background reference rate that is a rate of reference to the backing color in the pixel corresponding to the gap. (d1-1) may include determining the pixel background reference rate according to the texture value using a background reference rate determination curve determined by the on-thread texture threshold, the gap texture threshold, the on-thread background reference rate, and the gap background reference rate.

According to the method, the pixel background reference rate can be determined using the texture value of the texture information and the transmission characteristic information.
(6) In the above method, (e) may include (e1) determining a value proportional to one of the average background reference rate and the pixel background reference rate as an observation color mixing ratio, and (e2) creating the observation proof image data by executing a calculation of synthesizing the observation backing color with a color represented by the foreground color proof image data according to the observation color mixing ratio.

According to the method, it is possible to create the observation proof image data by synthesizing the observation backing color with the color represented by the foreground color proof image data using the observation color mixing ratio determined according to the texture information.
(7) According to a second aspect of the disclosure, a proof image data creation device is provided. The proof image data creation device includes a basic proof image acquisition unit that acquires basic proof image data for reproducing, by a proof output device, a color of a basic printed matter obtained by applying a basic backing to a translucent print fabric formed by printing an image on a translucent fabric by a printing machine, a texture information acquisition unit that acquires texture information of the translucent fabric, a backing color information acquisition unit that acquires a basic backing color that is a color of the basic backing and an observation backing color that is a color of an observation backing used in an observation environment of the translucent print fabric, a color correction unit that creates foreground color proof image data representing a color of the translucent print fabric observed without using a backing by executing color correction processing of removing the basic backing color from the color represented by the basic proof image data according to the texture information, and a synthesis unit that creates observation proof image data representing a color of an observation printed matter obtained by applying the observation backing to the translucent print fabric by executing synthesis processing of synthesizing the observation backing color with a color represented by the foreground color proof image data according to the texture information.
(8) According to a third aspect of the present disclosure, a non-transitory computer-readable storage medium storing a computer program for creating proof image data is provided. The computer program causes a computer to execute processing (a) of acquiring basic proof image data for reproducing, by a proof output device, a color of a basic printed matter obtained by applying a basic backing to a translucent print fabric formed by printing an image on a translucent fabric by a printing machine, processing (b) of acquiring texture information of the translucent fabric, processing (c) of acquiring a basic backing color that is a color of the basic backing and an observation backing color that is a color of an observation backing used in an observation environment of the translucent print fabric, processing (d) of creating foreground color proof image data representing a color of the translucent print fabric observed without using a backing by executing color correction processing of removing the basic backing color from a color represented by the basic proof image data according to the texture information, and processing (e) of creating observation proof image data representing a color of an observation printed matter obtained by applying the observation backing to the translucent print fabric by executing synthesis processing of synthesizing the observation backing color with a color represented by the foreground color proof image data according to the texture information.

The present disclosure can be implemented in various aspects other than the above-described aspects, and can be implemented as, for example, a computer program for implementing the function of the proof image data creation device. The present disclosure can also be implemented in an aspect of a non-transitory storage medium in which a computer program is recorded.

What is claimed is:

1. A method of creating proof image data comprising:
(a) acquiring basic proof image data for reproducing, by a proof output device, a color of a basic printed matter obtained by applying a basic backing to a translucent print fabric formed by printing an image on a translucent fabric by a printing machine;
(b) acquiring texture information of the translucent fabric;
(c) acquiring a basic backing color that is a color of the basic backing and an observation backing color that is a color of an observation backing used in an observation environment of the translucent print fabric;
(d) creating foreground color proof image data representing a color of the translucent print fabric observed without using a backing by executing color correction processing of removing the basic backing color from a color represented by the basic proof image data according to the texture information; and
(e) creating observation proof image data representing a color of an observation printed matter obtained by applying the observation backing to the translucent print fabric by executing synthesis processing of synthesizing the observation backing color with a color represented by the foreground color proof image data according to the texture information.

2. The method according to claim 1, wherein
(d) includes:
(d1) determining a basic color mixing ratio of the basic backing color when the color of the basic printed matter is regarded as a color mixture of the color of the translucent print fabric and the basic backing color according to the texture information; and
(d2) creating the foreground color proof image data by executing a calculation of removing the basic backing color from the color represented by the basic proof image data according to the basic color mixing ratio.

3. The method according to claim 1, wherein
the basic proof image data is data represented in an output color space of the proof output device, and
(d) includes:
(d1) determining a basic color mixing ratio of the basic backing color when the color of the basic printed matter is regarded as a color mixture of the color of the translucent print fabric and the basic backing color according to the texture information;
(d2) generating a color correction media profile related to the translucent fabric without the basic backing by executing profile conversion on a media profile of the printing machine related to the translucent fabric using the basic backing color and the basic color mixing ratio; and
(d3) creating the foreground color proof image data by executing color management processing of converting the basic proof image data into a device-independent color space using the color correction media profile.

4. The method according to claim 2, wherein
the texture information includes transmission characteristic information of the translucent fabric and a texture value for each pixel, and
(d1) includes:
(d1-1) determining a pixel background reference rate that is a rate of reference to a backing color in each pixel according to the texture value using the transmission characteristic information; and
(d1-2) determining a value proportional to one of an average background reference rate obtained by averaging the pixel background reference rates in an image area of the basic proof image data and the pixel background reference rate as the basic color mixing ratio.

5. The method according to claim 4, wherein
the transmission characteristic information includes:
an on-thread texture threshold for determining that each pixel corresponds to a portion on a weaving thread of the translucent fabric;
a gap texture threshold for determining that each pixel corresponds to a gap between weaving threads of the translucent fabric;
an on-thread background reference rate that is a rate of reference to the backing color in the pixel corresponding to the weaving thread; and
a gap background reference rate that is a rate of reference to the backing color in the pixel corresponding to the gap, and
(d1-1) includes determining the pixel background reference rate according to the texture value using a background reference rate determination curve determined by the on-thread texture threshold, the gap texture threshold, the on-thread background reference rate, and the gap background reference rate.

6. The method according to claim 4, wherein
(e) includes:
(e1) determining a value proportional to one of the average background reference rate and the pixel background reference rate as an observation color mixing ratio; and
(e2) creating the observation proof image data by executing a calculation of synthesizing the observation backing color with a color represented by the foreground color proof image data according to the observation color mixing ratio.

7. A proof image data creation device comprising:
a basic proof image acquisition unit that acquires basic proof image data for reproducing, by a proof output device, a color of a basic printed matter obtained by applying a basic backing to a translucent print fabric formed by printing an image on a translucent fabric by a printing machine;
a texture information acquisition unit that acquires texture information of the translucent fabric;
a backing color information acquisition unit that acquires a basic backing color that is a color of the basic backing and an observation backing color that is a color of an observation backing used in an observation environment of the translucent print fabric;
a color correction unit that creates foreground color proof image data representing a color of the translucent print fabric observed without using a backing by executing color correction processing of removing the basic backing color from the color represented by the basic proof image data according to the texture information; and
a synthesis unit that creates observation proof image data representing a color of an observation printed matter obtained by applying the observation backing to the translucent print fabric by executing synthesis processing of synthesizing the observation backing color with a color represented by the foreground color proof image data according to the texture information.

8. A non-transitory computer-readable storage medium storing a computer program, the computer program causing a computer to execute:
processing (a) of acquiring basic proof image data for reproducing, by a proof output device, a color of a basic printed matter obtained by applying a basic backing to a translucent print fabric formed by printing an image on a translucent fabric by a printing machine;
processing (b) of acquiring texture information of the translucent fabric;
processing (c) of acquiring a basic backing color that is a color of the basic backing and an observation backing color that is a color of an observation backing used in an observation environment of the translucent print fabric;
processing (d) of creating foreground color proof image data representing a color of the translucent print fabric observed without using a backing by executing color correction processing of removing the basic backing color from a color represented by the basic proof image data according to the texture information; and
processing (e) of creating observation proof image data representing a color of an observation printed matter obtained by applying the observation backing to the translucent print fabric by executing synthesis processing of synthesizing the observation backing color with a color represented by the foreground color proof image data according to the texture information.
